(19) United States
(12) Patent Application Publication
(10) Pub. No.: US 2023/0046301 A1
(43) Pub. Date: Feb. 16, 2023

(54) IMAGE FORMING APPARATUS

(71) Applicant: CANON KABUSHIKI KAISHA, Tokyo (JP)

(72) Inventors: Ryohei Yamamoto, Tokyo (JP); Takashi Hiratsuka, Chiba (JP); Tetsuro Sakamoto, Chiba (JP)

(21) Appl. No.: 17/861,303

(22) Filed: Jul. 11, 2022

(30) Foreign Application Priority Data
Aug. 16, 2021 (JP) 2021-132287

(51) Int. Cl. G03G 15/00; B65H 5/06

(52) U.S. Cl. CPC G03G 15/6579; B65H 5/062; G03G 2215/00679; G03G 2215/00675; B65H 2801/03; B65H 2404/143; B65H 2301/33312

(57) ABSTRACT

An image forming apparatus includes a reverse roller pair configured to reverse a conveyance direction of a recording medium between a first direction and a second direction, a first conveyance roller pair configured to convey the recording medium in the first direction, and a second conveyance roller pair configured to convey the recording medium in the second direction. A first distance is between the first conveyance roller pair and a reversal position in which a trailing edge of the recording medium is located when the conveyance direction is reversed. A second distance is between the reversal position and the second conveyance roller pair. An absolute value of a difference between the first distance and the second distance is an integer multiple of a circumferential length of a drive roller of the reverse roller pair or within a predetermined range from the integer multiple.

### BACKGROUND OF THE INVENTION

### Field of the Invention

The present invention relates to an image forming apparatus having a reverse roller pair configured to reverse a conveyance direction of a recording medium.

### Description of the Related Art

Conventionally, there is an image forming apparatus having a function of performing a one-sided image formation for forming an image on one side of a recording medium and a double-sided image formation for forming images on both sides of a recording medium. In a case in which the image forming apparatus performs the double-sided image formation, the conveyance direction of the recording medium is reversed (switched back) so that an upstream edge (trailing edge) of the recording medium conveyed from a fixing portion becomes a leading edge. The recording medium of which the conveyance direction is reversed is conveyed through a reverse conveyance path to an image forming portion again. The image forming portion forms an image on a back side of the recording medium to perform the double-sided image formation.

There is also an image forming apparatus having a function of performing a face-down discharge for the purpose of collating a stacking order of recording medium when the recording medium on which images are formed are to be stacked on the discharge tray during a continuous image formation. In order to perform the face-down discharge of the recording medium, there is also a case in that the conveyance direction of the recording medium conveyed from the fixing portion is reversed (switched back).

Japanese Patent Application Laid-Open No. 2016-132547 and Japanese Patent Application Laid-Open No. 2008-156005 disclose image forming apparatuses in each of which a reverse roller pair is provided downstream of a fixing portion in a conveyance direction of a recording medium conveyed from a fixing portion. A rotation direction of the reverse roller pair can be switched. The reverse roller pair nips the recording medium conveyed from the fixing portion, conveys the recording medium by a predetermined amount in the conveyance direction, and thereafter reversely rotates to switch back the recording medium. Thus, the image forming apparatuses disclosed in Japanese Patent Application Laid-Open No. 2016-132547 and Japanese Patent Application Laid-Open No. 2008-156005 perform the double-sided image formation.

In recent years, however, customer demand for image quality of image forming apparatuses has been increasing. In particular, higher accuracy is desired for a geometric image quality relating to an image formation position accuracy of an image with respect to a recording medium. In the image forming apparatus disclosed in Japanese Patent Application Laid-Open No. 2016-132547, since the recording medium is reversed by only the reverse roller pair, fluctuations occur in the image formation position accuracy of the image with respect to the recording medium for each of the conveying recording medium, and the geometric image quality deteriorates.

In the image forming apparatus of Japanese Patent Application Laid-Open No. 2008-156005, since a circumferential length of the reverse roller is measured during conveyance of the recording medium and the reverse timing in the conveyance direction of the recording medium is controlled based on the measured circumferential length, the positional accuracy of the recording medium in the conveyance direction is improved. However, the image forming apparatus disclosed in Japanese Patent Application Laid-Open No. 2008-156005 has a difficulty that fluctuations in the attitude (direction) of the recording medium with respect to the conveyance direction cannot be reduced.

### SUMMARY OF THE INVENTION

According to an embodiment of the present invention, an image forming apparatus is configured to form an image on a recording medium, the image forming apparatus comprising: a reverse roller pair including a drive roller and a driven roller driven by a rotation of the drive roller, and configured to reverse a conveyance direction of the recording medium between a first direction and a second direction opposite to the first direction; a motor configured to drive the drive roller; a first conveyance roller pair disposed upstream of the reverse roller pair in the first direction and configured to convey the recording medium in the first direction; and a second conveyance roller pair disposed downstream of the reverse roller pair in the second direction and configured to convey the recording medium in the second direction, wherein in a case in which a distance between the first conveyance roller pair and a reversal position in which a trailing edge of the recording medium conveyed in the first direction is located when the conveyance direction is reversed from the first direction to the second direction by the reverse roller pair is assumed to be a first distance and a distance between the reversal position and the second conveyance roller pair is assumed to be a second distance, the reverse roller pair, the first conveyance roller pair, and the second conveyance roller pair are configured so that an absolute value of a difference between the first distance and the second distance is an integer multiple of a circumferential length of the drive roller or within a predetermined range from the integer multiple.

Further features of the present invention will become apparent from the following description of exemplary embodiments with reference to the attached drawings.

### BRIEF DESCRIPTION OF THE DRAWINGS

FIG. 1 is a cross-sectional view of an image forming apparatus.

FIG. 2 is a view showing a reverse discharge portion according to a first embodiment.

FIG. 3A, FIG. 3B, and FIG. 3C are explanatory views of a circumferential velocity fluctuation that occurs in one rotation period of a discharge drive roller.

FIG. 4A and FIG. 4B are explanatory views of a fluctuation in a skew amount of a sheet caused by a periodic fluctuation in a difference velocity.

FIG. 5A and FIG. 5B are views showing the fluctuation in the skew amount of the sheet during a switchback.

FIG. 6 is a view showing a relationship between a conveyance distance of the sheet and a phase of the discharge drive roller.

FIG. 7A and FIG. 7B are explanatory views of a relationship between the difference velocity and fluctuations in skew amounts.

FIG. 8 is a view showing a relationship between a maximum skew amount and a difference between a first distance and a second distance.

FIG. 9A and FIG. 9B are explanatory views of an error occurring in the skew amount by an effect of a conveyance efficiency.

FIG. 10 is a view showing a reverse discharge portion according to a second embodiment.

FIG. 11 is a view showing a conveyance efficiency prediction table.

FIG. 12A and FIG. 12B are flowcharts of a switchback control operation performed by a controller.

FIG. 13 is a view showing a reverse discharge portion according to a third embodiment.

FIG. 14 is a view showing a relationship between a cumulative number of passing sheets and a forward way conveyance efficiency.

FIG. 15 is a view showing a parameter table.

FIG. 16 is a flowchart of a switchback control operation performed by the controller.

### DESCRIPTION OF THE EMBODIMENTS

### First Embodiment

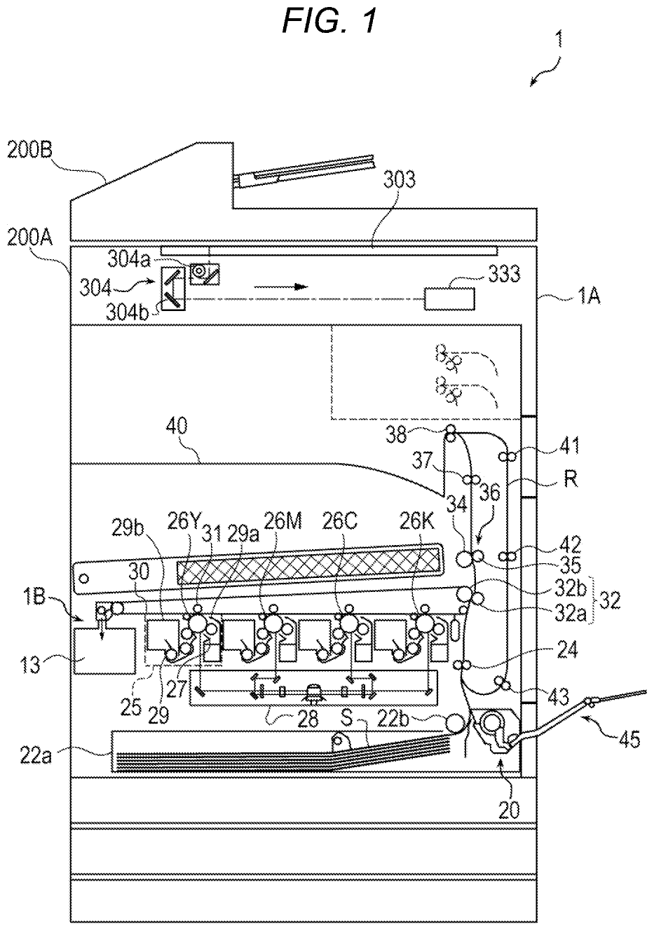

Hereinafter, the first embodiment will be described in detail with reference to FIG. 1 to FIG. 8.

### (Image Forming Apparatus)

FIG. 1 is a cross-sectional view of an image forming apparatus 1. The image forming apparatus 1 has an image forming apparatus main body (hereinafter referred to as an apparatus main body) 1A. An image reading apparatus 200A configured to read an image of an original and an automatic original feeding apparatus 200B configured to feed the original are disposed on an upper portion of the apparatus main body 1A. The apparatus main body 1A is provided with an image forming portion 1B configured to form an image on a recording medium (hereinafter referred to as a sheet) S, a feeding portion 20 configured to feed the sheet S, and a fixing portion 36 configured to fix a toner image formed on the sheet S.

The image forming portion 1B is provided with process cartridges 25 configured to form toner images of four colors of yellow, magenta, cyan, and black, respectively, which are detachably mounted to the apparatus main body 1A. The process cartridges 25 include photosensitive drums 26 (26Y, 26M, 26C, 26K), respectively. The image forming portion 1B includes a scanner unit 28 disposed vertically below the process cartridges 25. The scanner unit 28 irradiates the photosensitive drums 26 with a laser beams based on image information to form electrostatic latent images on the photosensitive drums 26. Each of the process cartridges 25 includes, around the photosensitive drum 26, a charging device 27 configured to uniformly charge a surface of the photosensitive drum 26, a developing device 29 configured to make toner adhere to the electrostatic latent image to develop the image as a toner image, and a drum cleaner 29a.

Primary transfer rollers 31 are disposed inside an intermediate transfer belt 30 so as to be opposed to the photosensitive drums 26, respectively. The primary transfer rollers 31 apply primary transfer biases to the intermediate transfer belt 30 so that the toner images of respective colors on the photosensitive drums 26 are sequentially transferred to the intermediate transfer belt 30, thereby a full-color toner image is formed on the intermediate transfer belt 30. A secondary transfer portion 32 transfers the full-color toner image formed on the intermediate transfer belt 30 to the sheet S. The secondary transfer portion 32 includes a drive roller 32b that serves also as a secondary transfer inner roller rotated by a drive gear (not shown), and a secondary transfer roller 32a.

The fixing portion 36 heats and pressurizes the toner image transferred on the sheet S to fix the toner image to the sheet S. The fixing portion 36 has a heating roller 34 and a pressure roller 35 in pressure contact with the heating roller 34. The feeding portion 20 includes a feeding cassette 22a detachably mounted to the apparatus main body 1A and a pickup roller 22b. A manual feed portion 45 feeds a sheet S placed on the manual feed portion 45.

### (Image Forming Operation)

Next, an image forming operation of the image forming apparatus 1 will be described with reference to FIG. 1. In a case in which an original is placed on a contact glass 303, an image reading portion 304 scans in the arrow direction under the contact glass 303. Light emitted from a light source 304a is reflected by a surface of the original and then reflected by mirrors 304b to enter a charge coupled device (hereinafter referred to as CCD) 333. The CCD 333 converts a received reflected light into an electric signal (image signal) as image information. In a case in which an image of an original set on the automatic original feeding apparatus 200B is read, the image reading portion 304 is stopped at a position shown in FIG. 1. The originals are separated by the automatic original feeding apparatus 200B and conveyed one by one to the contact glass 303. The original is conveyed by the automatic original feeding apparatus 200B on the surface of the contact glass 303 opposite to the image reading portion 304. The image reading portion 304 reads the image of the original conveyed by the automatic original feeding apparatus 200B. The image forming apparatus 1 functions as a copying machine when the image signal from the CCD 333 is input to an image processing portion (not shown), and functions as a printer when an image signal from a personal computer is input to the image processing portion (not shown).

The image information converted into the electric signal by the CCD 333 is processed by the image processing portion (not shown) and then transmitted to the scanner unit 28. The scanner unit 28 emits a laser beam according to the electric signal as image information. The laser beam is irradiated onto the surface of the photosensitive drum 26. The surface of the photosensitive drum 26 is uniformly charged to a predetermined potential of a predetermined polarity by the charging device 27. The laser beam emitted from the scanner unit 28 is irradiated onto the uniformly charged surface of the photosensitive drum 26 so that an electrostatic latent image is formed on the surface of the photosensitive drum 26. The developing device 29 develops the electrostatic latent image with toner to form a toner image.

In a case in which a color image is to be formed, for example, the photosensitive drum 26Y is first irradiated with a laser beam according to an image signal of a yellow component color of an original from the scanner unit 28 to form a yellow electrostatic latent image on the surface of the photosensitive drum 26Y. The developing device 29 develops the yellow electrostatic latent image with yellow toner from a toner containing portion 29b to form a yellow toner image.

The yellow toner image reaches a primary transfer portion in which the photosensitive drum 26Y and the intermediate transfer belt 30 abut against each other as the photosensitive drum 26Y rotates. The yellow toner image on the photosensitive drum 26Y is transferred onto the intermediate transfer belt 30 by the primary transfer bias applied to the primary transfer roller 31.

The yellow toner image on the intermediate transfer belt 30 reaches a primary transfer portion in which the photosensitive drum 26M and the intermediate transfer belt 30 abut against each other as the intermediate transfer belt 30 rotates. By this time, a magenta toner image formed on the photosensitive drum 26M by the same method as described above is transferred and superposed on the yellow toner image on the intermediate transfer belt 30. Similarly, as the intermediate transfer belt 30 moves, a cyan toner image and a black toner image are transferred in primary transfer portions, respectively, and superposed on the yellow toner image and the magenta toner image. Thus, a color toner image is formed on the intermediate transfer belt 30. After the toner images are transferred, the toners remaining on the surfaces of the photosensitive drums 26 are removed by the drum cleaners 29a, respectively. The removed toners are recovered in a recovery toner container 13.

In parallel with the toner image forming operation, the sheet S contained in the feeding cassette 22a is fed by the pickup roller 22b and reaches a registration roller pair 24. Alternatively, the sheet S placed on the manual feed portion 45 reaches the registration roller pair 24. The registration roller pair 24 conveys the sheet S to the secondary transfer portion 32 so that a leading edge of the sheet S coincides with a leading edge of the toner image on the intermediate transfer belt 30 at the secondary transfer portion 32. In the secondary transfer portion 32, the toner images of four colors on the intermediate transfer belt 30 are collectively transferred onto the sheet S by the secondary transfer bias applied to the secondary transfer roller 32a.

The sheet S to which the toner image has been transferred is conveyed to the fixing portion 36. When the sheet S passes through a nip formed by the heating roller 34 and the pressure roller 35 in pressure contact with the heating roller 34, the unfixed toner image on the sheet S is heated and pressurized. As a result, the color print image is fixed to the sheet S as a permanent image. The sheet S to which the color print image has been fixed is conveyed to a discharge roller pair 38 (reverse roller pair), which can forwardly and reversely rotate, by a discharge upstream roller pair 37 (first conveyance roller pair) as a conveyance unit. The sheet S is discharged to a discharge tray 40 by the discharge roller pair 38 and stacked on the discharge tray 40.

The image forming apparatus 1 can form images on both sides of the sheet S. In a case in which images are formed on both sides of the sheet S, before the sheet S having the image formed on the first side is discharged to the discharge tray 40 by the discharge roller pair 38, the discharge roller pair 38 is reversely rotated to allow the sheet S to enter a reverse conveyance path R (second conveyance path) which is a sheet conveyance path. The sheet S entering the reverse conveyance path R is conveyed to the registration roller pair 24 by a discharge downstream roller pair 41 (second conveyance roller pair) and conveyance roller pairs 42 and 43 provided in the reverse conveyance path R. The sheet S is again conveyed to the image forming portion 1B by the registration roller pair 24, and a toner image is formed on a second side of the sheet S. The sheet S having the toner image formed on the second side is conveyed to the fixing portion 36. The fixing portion 36 fixes the toner image to the second side of the sheet S to form an image on the second side. The sheet S on which the images have been formed on both sides is discharged to the discharge tray 40 by the discharge roller pair 38.

### (Reverse Discharge Portion)

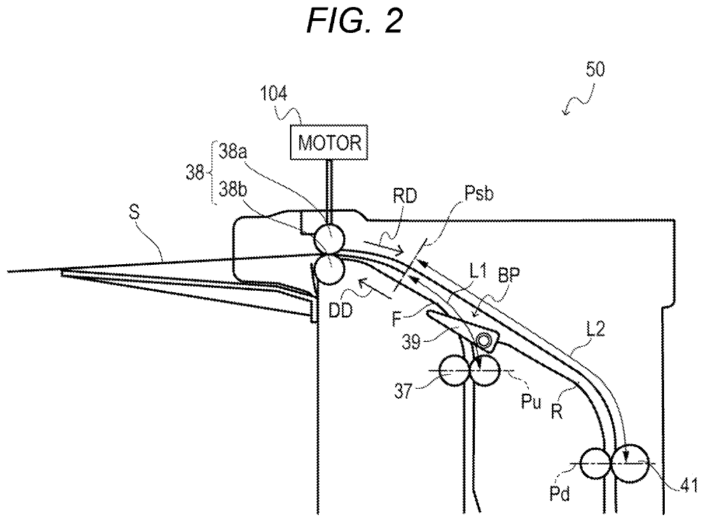

Next, with reference to FIG. 2, a reverse discharge portion 50 configured to change the conveyance direction of the sheet S will be described. FIG. 2 is a view showing the reverse discharge portion 50 according to the first embodiment. In a case in which images are formed on both sides of the sheet S, the sheet S having an image formed on one side thereof is conveyed to the discharge roller pair 38 (roller pair) in a discharge direction DD (first direction) along a forward conveyance path F (first conveyance path) as a discharge conveyance path by the discharge upstream roller pair 37 as the conveyance unit. The discharge upstream roller pair 37 is disposed upstream of the discharge roller pair 38 in the discharge direction DD. The discharge roller pair 38 includes a discharge drive roller 38a (drive roller) and a discharge driven roller 38b (driven roller). A motor 104 as a discharge roller drive unit is connected to the discharge drive roller 38a to transmit drive to the discharge drive roller 38a. A reverse flapper 39 is disposed at a branch-off portion BP of the forward conveyance path F and the reverse conveyance path R, and is rotated by the sheet S conveyed in the discharge direction DD abutting against the reverse flapper 39. When a leading edge of the sheet S passes through the reverse flapper 39 and enters a nip of the discharge roller pair 38, the sheet S is conveyed in the discharge direction DD by the discharge roller pair 38 and the discharge upstream roller pair 37. When a trailing edge of the sheet S passes through the reverse flapper 39 and reaches a switchback position Psb (reverse position), the forward rotation of the discharge roller pair 38 is stopped and the reverse rotation is started (switchback is performed). The sheet S is conveyed by the discharge roller pair 38 in a reverse direction RD (second direction) opposite to the discharge direction DD, with the trailing edge in the discharge direction DD serving as the leading edge. In the discharge direction DD, the sheet S is conveyed by a first distance L1 extending from a position Pu at which the trailing edge of the sheet S leaves the discharge upstream roller pair 37 to the switchback position Psb at which the trailing edge of the sheet S reaches when the sheet S is stopped by the switchback.

After the switchback, the sheet S is conveyed along the reverse conveyance path R switched by the reverse flapper 39 and enters the discharge downstream roller pair 41, which is a conveyance roller pair disposed downstream of the discharge roller pair 38 in the reverse direction RD. The sheet S conveyed in the reverse direction RD is conveyed by a second distance L2 extending from the switchback position Psb at which the leading edge of the sheet S is positioned to a position Pd at which the leading edge of the sheet S enters the discharge downstream roller pair 41. In the switchback operation, fluctuations in the attitude of the sheet S with respect to the discharge direction DD is more likely to occur in a case in which the sheet S is conveyed by only the discharge roller pair 38 than in a case in which the sheet S is conveyed by both the discharge roller pair 38 and the discharge upstream roller pair 37. Similarly, fluctuations in the attitude of the sheet S with respect to the reverse direction RD are more likely to occur in a case in which the sheet S is conveyed by only the discharge roller pair 38 than in a case in which the sheet S is conveyed by both the discharge roller pair 38 and the discharge downstream roller pair 41.

### (Fluctuation in Skew Amount)

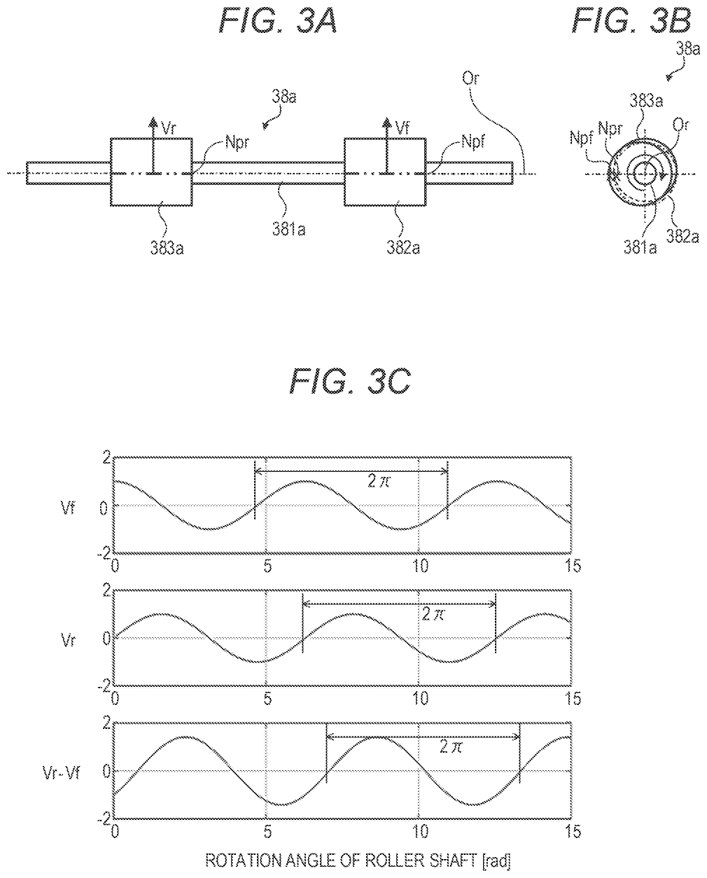

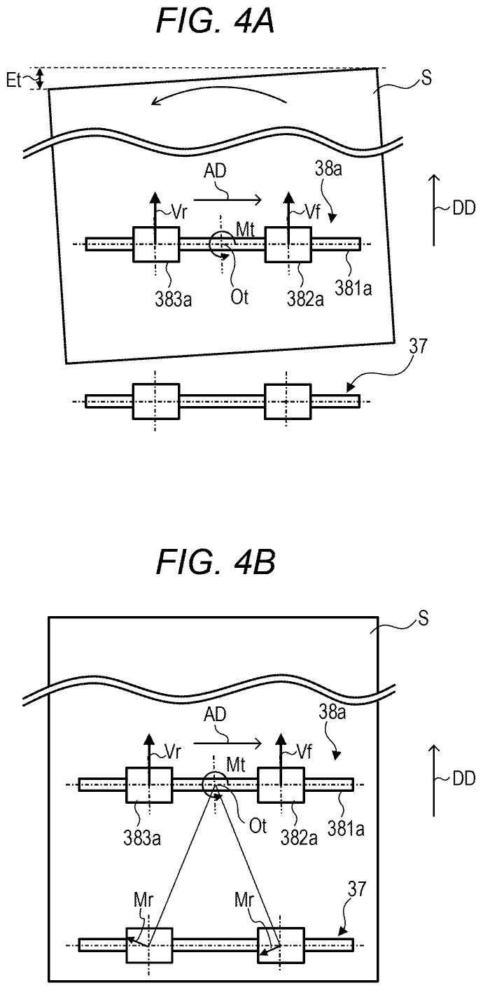

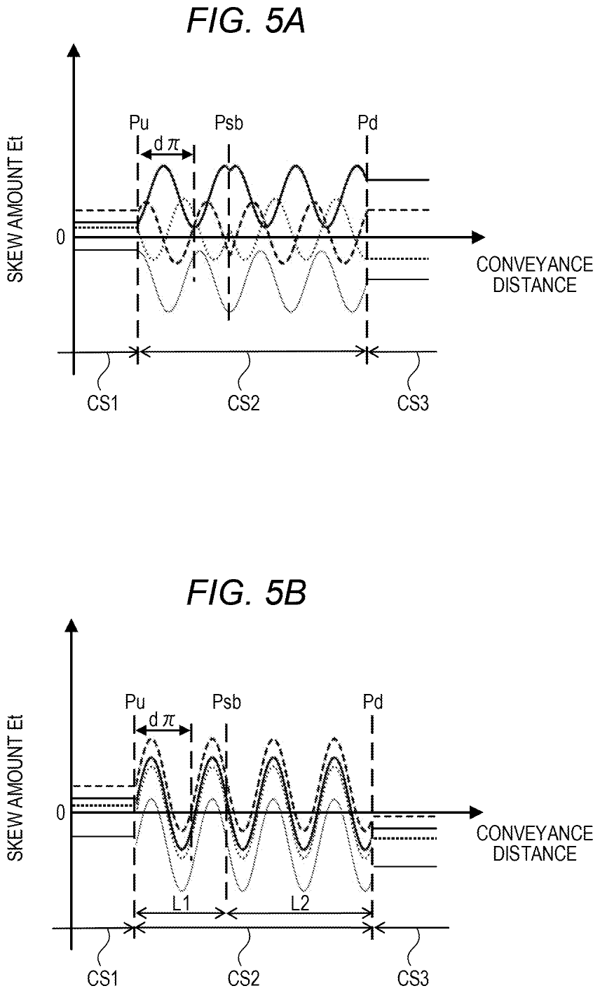

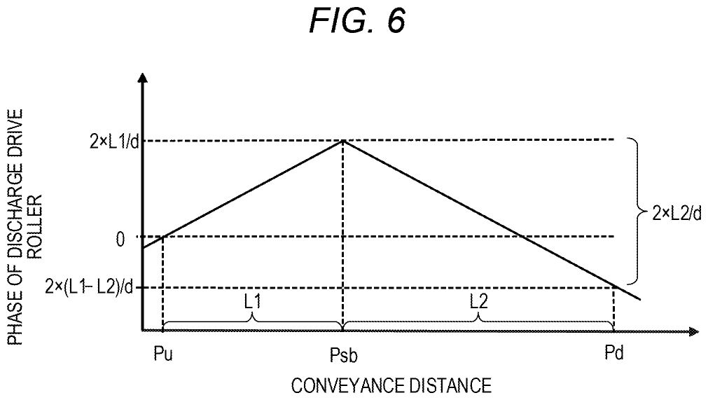

With reference to FIG. 3A, FIG. 3B, FIG. 3C, FIG. 4A, FIG. 4B, FIG. 5A, FIG. 5B, and FIG. 6, the fluctuation in the skew amount of the sheet S occurring in one rotation period of the discharge drive roller 38a will be described. FIG. 3A, FIG. 3B, and FIG. 3C are explanatory views of a circumferential velocity fluctuation that occurs in one rotation period of the discharge drive roller 38a. FIG. 3A is a front view of the discharge drive roller 38a. FIG. 3B is a side view of the discharge drive roller 38a. The discharge drive roller 38a comprises a front side rubber member 382a, a back side rubber member 383a, and a roller shaft 381a which is press-fitted into the front side rubber member 382a and the back side rubber member 383a in the axial direction of the front side rubber member 382a and the back side rubber member 383a. The roller shaft 381a is rotatably supported by a rotation support member (not shown) and connected to a drive transmission unit (not shown). The motor 104 is connected to the drive transmission unit (not shown). The roller shaft 381a is rotated about an axis center Or by the driving force from the motor 104. The front side rubber member 382a and the back side rubber member 383a nip the sheet S at nip positions Npf and Npr, respectively. The sheet S is conveyed at a circumferential velocity Vf at the nip position Npf. The sheet S is conveyed at a circumferential velocity Vr at the nip position Npr.

The front side rubber member 382a and the back side rubber member 383a are press-fitted onto the roller shaft 381a with an axis center of the front side rubber member 382a and an axis center of the back side rubber member 383a being out of alignment with the axis center Or of the roller shaft 381a (so-called misalignment in centering) due to fluctuation in machining accuracy. Therefore, a distance between the nip position Npf and the axis center Or and a distance between the nip position Npr and the axis center Or, that is, a radius of rotation of the nip position Npf and a radius of rotation of the nip position Npr vary as the roller shaft 381a rotates. As a result, the circumferential velocity Vf at the nip position Npf and the circumferential velocity Vr at the nip position Npr also vary as the roller shaft 381a rotates.

FIG. 3C is a view showing fluctuations in the circumferential velocities Vf and Vr and a fluctuation in a difference velocity Vr−Vf between the circumferential velocities Vf and Vr with respect to a rotation angle of the roller shaft 381a. Since the circumferential velocities Vf and Vr vary as the roller shaft 381a rotates, the circumferential velocities Vf and Vr vary periodically for each rotation (2π) of the roller shaft 381a. In the first embodiment, the front side rubber member 382a and the back side rubber member 383a are misalignment in centering in different phases with respect to the roller shaft 381a. As a result, the phases of the fluctuations in the circumferential velocities Vf and Vr are different. Therefore, according to the geometry, the difference velocity Vr−Vf between the circumferential velocities Vr and Vf varies periodically for each rotation (2π) of the roller shaft 381a in the same manner as the circumferential velocities Vr and Vf. As the difference velocity Vr−Vf periodically varies, the attitude of the sheet S with respect to the conveyance direction periodically varies.

FIG. 4A and FIG. 4B are explanatory views of a fluctuation in a skew amount of the sheet S caused by the periodic fluctuation in the difference velocity Vr−Vf FIG. 4A shows a sheet S being conveyed by only the discharge roller pair 38. When a difference occurs between the circumferential velocities Vf and Vr, a turning moment Mt around a central position Ot between the front side rubber member 382a and the back side rubber member 383a in the axial direction AD of the roller shaft 381a acts on the sheet S. The sheet S is turned around the central position Ot by the turning moment Mt, the attitude of the sheet S is tilted with respect to the discharge direction DD, so that the sheet S is fed skew. When the difference velocity Vr−Vf periodically varies for each rotation of the roller shaft 381a, the turning moment Mt also periodically varies synchronously, and as a result, the skew amount Et of the sheet S also periodically varies.

On the other hand, in a case in which a sheet S is nipped and conveyed by a plurality of roller pairs, the behavior of the sheet S is different from that in a case in which the sheet S is nipped and conveyed by only the discharge roller pair 38. FIG. 4B shows a sheet S being conveyed by the discharge roller pair 38 and the discharge upstream roller pair 37. In the case shown in FIG. 4B, similarly to the case shown in FIG. 4A, the difference between the circumferential velocities Vf and Vr causes the turning moment Mt about the central position Ot to act on the sheet S. However, at the nip positions of the discharge upstream roller pair 37, frictional resistances are generated between the discharge upstream roller pair 37 and the sheet S, and resistance moments Mr are generated in a direction to cancel the turning moment Mt. As a result, the total moment acting on the sheet S becomes almost 0 (Mt−2×Mr≈0), and the generated skew amount Et becomes small. Therefore, the periodic skew fluctuation of the sheet S is particularly large in a section in which the sheet S is conveyed by only the discharge roller pair 38.

FIG. 5A and FIG. 5B are views showing the fluctuation in the skew amount Et of the sheet S during the switchback (during the surface reverse). FIG. 5A is a view showing a relationship between a conveyance distance of the sheet S and the skew amount Et in the conventional switchback conveyance. In FIG. 5A, the relationships between the conveyance distances of the plurality of sheets S and the skew amounts Et are represented by a thick line, a thin line, a dashed line, and a dotted line, respectively. In a first conveyance section CS1 in which the sheet S is conveyed by both the discharge roller pair 38 and the discharge upstream roller pair 37, the skew amount Et with respect to the conveyance distance of the sheet S is substantially constant. In a second conveyance section CS2 in which the sheet S is conveyed by only the discharge roller pair 38, the skew amount Et with respect to the conveyance distance of the sheet S changes according to the phase of the discharge drive roller 38a. In a third conveyance section CS3 in which the sheet S is conveyed by both the discharge roller pair 38 and the discharge downstream roller pair 41, the skew amount Et with respect to the conveyance distance of the sheet S is substantially constant.

The second conveyance section CS2 in which the sheet S is conveyed by only the discharge roller pair 38 is a section from a time when the trailing edge of the sheet S leaves the position Pu of the discharge upstream roller pair 37 to a time when the leading edge of the switched back sheet S enters the position Pd of the discharge downstream roller pair 41. In the second conveyance section CS2, the skew amount Et varies greatly and periodically. The period of fluctuation in the skew amount Et corresponds to one rotation period of the discharge drive roller 38a. The conveyance distance during one rotation of the discharge drive roller 38a is approximately “dπ”. “d” is a diameter of the discharge drive roller 38a. “dπ” is a circumferential length of the discharge drive roller 38a.

Since the phase of the discharge drive roller 38a when the trailing edge of the sheet S leaves the position Pu of the discharge upstream roller pair 37 is different in each of the plurality of sheets S, the skew amount Et at the position Pu is also different in each of the plurality of sheets S. In any of the sheets S, the skew amount Et at a position at which the trailing edge of the sheet S is conveyed by the circumferential length “dπ” of the discharge drive roller 38a from the position Pu where the trailing edge of the sheet S has left the discharge upstream roller pair 37 is substantially the same as the skew amount Et at the position Pu. However, since the skew amount Et at a position other than the position at which the sheet is conveyed by a conveyance distance of an integer multiple of the circumferential length “dπ” is different from the skew amount Et at the position Pu, the skew amount Et for each sheet S varies greatly.

In the conventional art, a phase of the discharge drive roller 38a at the timing when the trailing edge of the sheet S has left the position Pu is different from a phase of the discharge drive roller 38a at the timing when the leading edge of the switched back sheet S enters the position Pd. Accordingly, in the conventional art, the skew amount Et varies greatly for each sheet S. Therefore, in the conventional art, the accuracy of the image formation position with respect to the sheet S in the double-sided image formation is lowered.

FIG. 6 is a view showing a relationship between the conveyance distance of the sheet S and the phase of the discharge drive roller 38a. In FIG. 6, the phase of the discharge drive roller 38a at the position Pu is set to “0”. In a case in which the sheet S is conveyed from the position Pu toward the switchback position Psb by the forward rotation of the discharge drive roller 38a, the phase of the discharge drive roller 38a is made positive.

As shown in FIG. 2, a conveyance distance from the position Pu to the switchback position Psb is defined as a first distance L1. Assuming that the phase of the discharge drive roller 38a when the trailing edge of the sheet S has left the position Pu is “0”, the phase of the discharge drive roller 38a when the trailing edge of the sheet S reaches the switchback position Psb is 2×L1/d (=2π×L1/dπ). As shown in FIG. 2, a conveyance distance from the switchback position Psb to the position Pd is defined as a second distance L2. The phase of the discharge drive roller 38a when the leading edge of the sheet S conveyed in the reverse direction RD after the switchback reaches the position Pd is 2×(L1−L2)/d because the phase of the discharge drive roller 38a rotates reversely by 2×L2/d from 2×L1/d.

Therefore, a difference between the phase “0” of the discharge drive roller 38a when the trailing edge of the sheet S has left the position Pu and the phase 2×(L1−L2)/d of the discharge drive roller 38a when the leading edge of the switched back sheet S enters the position Pd is expressed by the following Equation (1).

2×(L1−L2)/d Equation (1)

In the first embodiment, an absolute value of a difference between the first distance L1 and the second distance L2 is set to be an integer multiple of the circumferential length “dπ” of the discharge drive roller 38a.

|L1−L2|=ndπ Equation (2)

Substituting Equation (2) into Equation (1) yields λnπ. “n” is a predetermined integer value. Therefore, the phase of the discharge drive roller 38a when the trailing edge of the sheet S has left the position Pu is substantially the same as the phase of the discharge drive roller 38a when the leading edge of the switched back sheet S enters the position Pd.

FIG. 5B is a view showing a relationship between the conveyance distance and the skew amount Et in the switchback conveyance by the reverse discharge portion 50 of the first embodiment. In FIG. 5B, the relationships between the conveyance distances and the skew amounts Et of the plurality of sheets S are represented by a thick line, a thin line, a broken line, and a dotted line, respectively. According to the first embodiment, the phase of the discharge drive roller 38a when the trailing edge of the sheet S has left the position Pu is substantially the same as the phase of the discharge drive roller 38a when the leading edge of the switched back sheet S enters the position Pd. Accordingly, the fluctuation in the skew amount Et for each sheet S is reduced.

(Allowable Range of Difference between Conveyance Distances)

Next, an allowable range Pr for a deviation amount of the difference between the first distance L1 and the second distance L2 with respect to the integer multiple ndπ of the circumferential length “dπ” of the discharge drive roller 38a will be described. It is known that the visibility limit Tvs of the visual of the human eye is equivalent to 300 dpi (=0.0847 mm). Therefore, it is desirable to have a roller arrangement configuration in which a maximum skew amount E_{L max} generated in the phase of the discharge drive roller 38a, in which the deviation amount of the image formation position with respect to the sheet S caused by the skew feeding of the sheet S is maximum, does not exceed 0.0847 mm of the visibility limit Tvs. Accordingly, a relationship between a deflection of the discharge drive roller 38a and the skew feeding is theoretically obtained, and the allowable range Pr for satisfying the roller arrangement such that the visibility limit Tvs is not exceeded even under the condition of the maximum skew amount E_{L max} is determined.

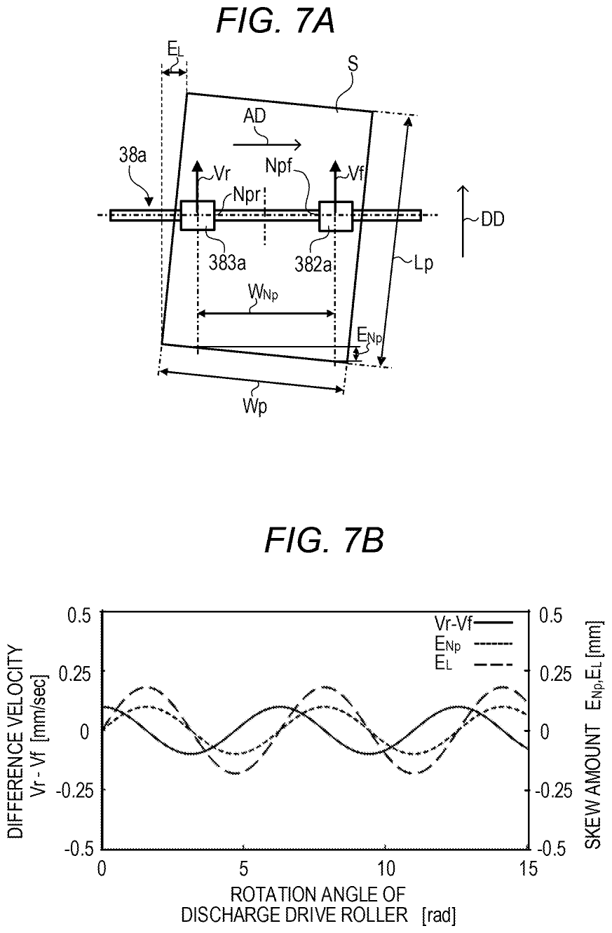

FIG. 7A and FIG. 7B are explanatory views of a relationship between the difference velocity Vr−Vf and the fluctuations in the skew amounts E_{N p} and E_{L}. FIG. 7A is a schematic view showing a case in which the sheet S is conveyed by the discharge drive roller 38a. In the first embodiment, an interval W_{N p} between the nip positions Npf and Npr in the axial direction AD is 80 mm, which is a value of a general discharge roller, and the misalignment in centering is 0.05 mm on one side, and the phase is in an opposite phase condition on the front and back sides in which the skew movement is maximized. In a correction unit in which the sheet S is abutted against a registration roller in a stopped state, which is a general registration configuration, and a loop is formed on the sheet S to correct the skew feeding, the skew correction is more difficult as the size of the sheet S becomes smaller. Therefore, the sheet S in the first embodiment is a postcard paper of the smallest size which the image forming apparatus 1 can address. A long side Lp of the postcard paper is 145 mm (Lp=145 mm) and a short side Wp is 100 mm (Wp=100 mm).

In FIG. 7B, the horizontal axis represents the rotation angle of the discharge drive roller 38a when the sheet S is conveyed by the discharge drive roller 38a. FIG. 7B is a view showing the difference velocity Vr−Vf between the circumferential velocities Vr and Vf of the discharge drive roller 38a, the skew amount E_{N p} between the nip positions Npf and Npr, and the skew amount E_{L} with respect to the discharge direction DD of the sheet S with respect to the rotation angle of the discharge drive roller 38a. The skew amount E_{N p} can be obtained by integrating the difference velocity Vr−Vf and is expressed by the following Equation (3).

E_{NP}=∫(Vr−Vf)dt Equation (3)

Further, the skew amount E_{L} of the long side of the sheet S which is larger than the skew amount Et of the short side of the sheet S caused by the skew feeding of the sheet S is obtained. The skew amount E_{L} of the long side with respect to the discharge direction DD (conveyance direction) is calculated by the following Equation (4) by considering the sheet S as a rigid body using the skew amount E_{N p} between the nip positions Npf and Npr obtained by Equation (3).

$${E}_{L} = {E}_{N p} \times \frac{L p}{{W}_{Np}} \qquad Equation ( 4 )$$

It can be seen that the skew amount E_{N p} is a periodic function because the skew amount E_{N p} is calculated by integrating the difference velocity Vr−Vf which is a periodic function from Equation (3). The skew amount E_{L} is a periodic function having the same phase and different amplitude from the skew amount E_{N p} between the nip positions Npf and Npr.

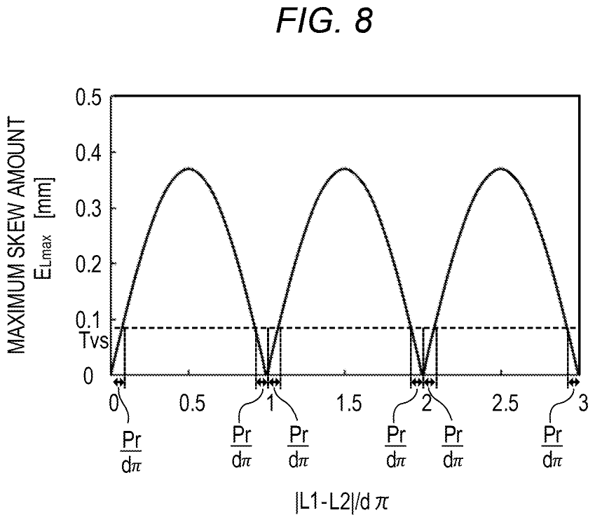

From a fluctuation curve of the skew amount E_{L} of the sheet S obtained from Equation (4), the maximum skew amount E_{L max} in various roller arrangements can be obtained. FIG. 8 is a view showing a relationship between the maximum skew amount E_{L max} and the difference between the first distance L1 and the second distance L2. In FIG. 8, the horizontal axis represents a value obtained by dividing the absolute value of the difference between the first distance L1 and the second distance L2 by the circumferential length “dπ” of the discharge drive roller 38a. In FIG. 8, the vertical axis represents the maximum skew amount E_{L max}. As can be seen from FIG. 8, the maximum skew amount E_{L max} decreases as the absolute value of the difference between the first distance L1 and the second distance L2 approaches ndπ, which is an integer multiple of the circumferential length “dπ”. That is, in FIG. 8, the maximum skew amount E_{L max} is smaller as the value of |L1−L2|/ndπ is closer to the integer value of 1, 2, or 3. At this time, the allowable range Pr within which the maximum skew amount E_{L max} is 0.0847 mm or less of the visibility limit Tvs is obtained. From FIG. 8, it can be seen that in order to satisfy the desired image quality, a deviation between the integer value and the value obtained by dividing the absolute value of the difference between the first distance L1 and the second distance L2 by the circumferential length “dπ” must be 0.076 or less. Therefore, the allowable range Pr of the absolute value of the difference between the first distance L1 and the second distance L2 with respect to the value ndπ which is the integer multiple of the circumferential length “dπ” of the discharge drive roller 38a is 0.076×dπ.

|L1−L2|−ndπ≤±0.076×dπ

In the first embodiment, the first distance L1 and the second distance L2 are set so that the absolute value of the difference between the first distance L1 and the second distance L2 is within a predetermined range from an integer multiple or the integer multiple of the circumferential length “dπ” of the discharge drive roller 38a. The predetermined range is a range of values of ±0.076 times the circumferential length “dπ” of the discharge drive roller 38a. This reduces the skew caused by the misalignment in centering of the discharge drive roller 38a and the fluctuation in the skew. Further, the deviation between the absolute value of the difference between the distance in the forward conveyance path F and the distance in the reverse conveyance path R for the conveyance by only the discharge roller pair 38 and the ndπ is suppressed to 0.076 times or less of the circumferential length “dπ” of the discharge drive roller 38a which is the allowable range Pr. As a result, the skew amount generated can be suppressed to be less than the visibility limit Tvs of the human eye.

According to the first embodiment, the phases of the discharge drive roller 38a at the first and last timings of the section in which the sheet S is conveyed by only the discharge roller pair 38 (reverse roller pair), respectively, are substantially the same. As a result, the attitude fluctuations of the sheet S generated in one rotation period of the discharge drive roller 38a at the beginning and end of the section, respectively, are also substantially the same, so that the attitude fluctuation of the sheet S with respect to the conveyance direction can be reduced. According to the first embodiment, the fluctuation in the attitude of the sheet S in a case in which the conveyance direction of the sheet S is reversed can be reduced.

### Second Embodiment

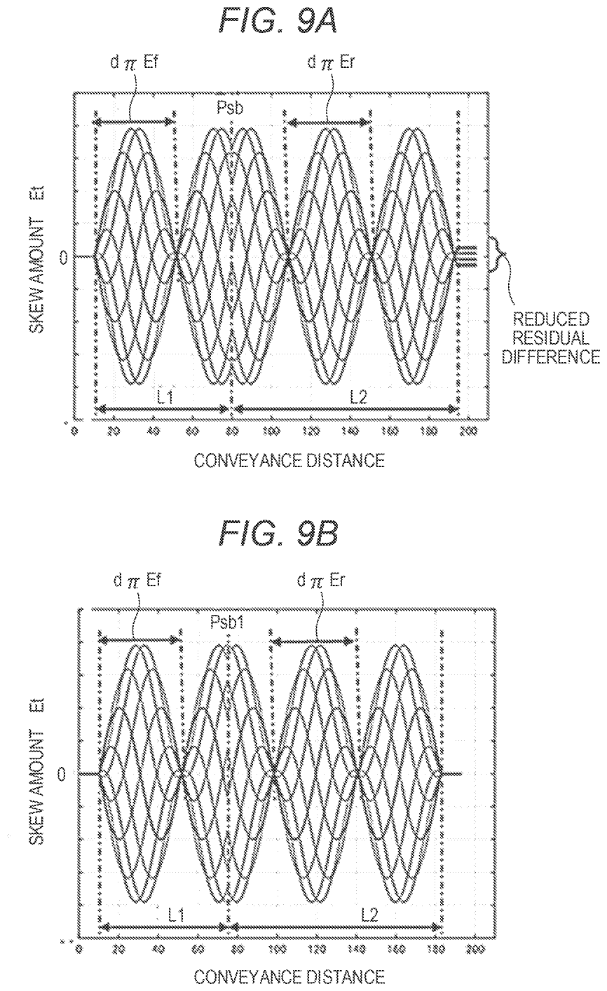

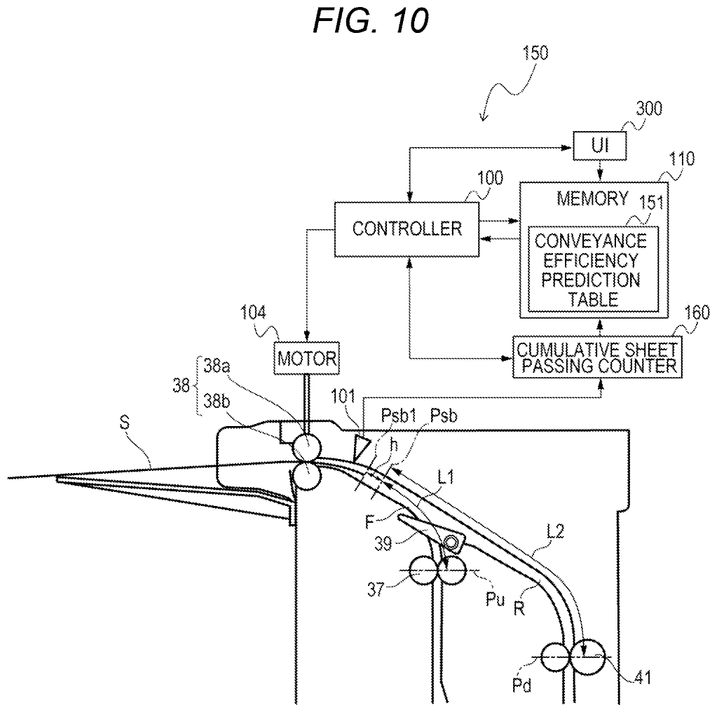

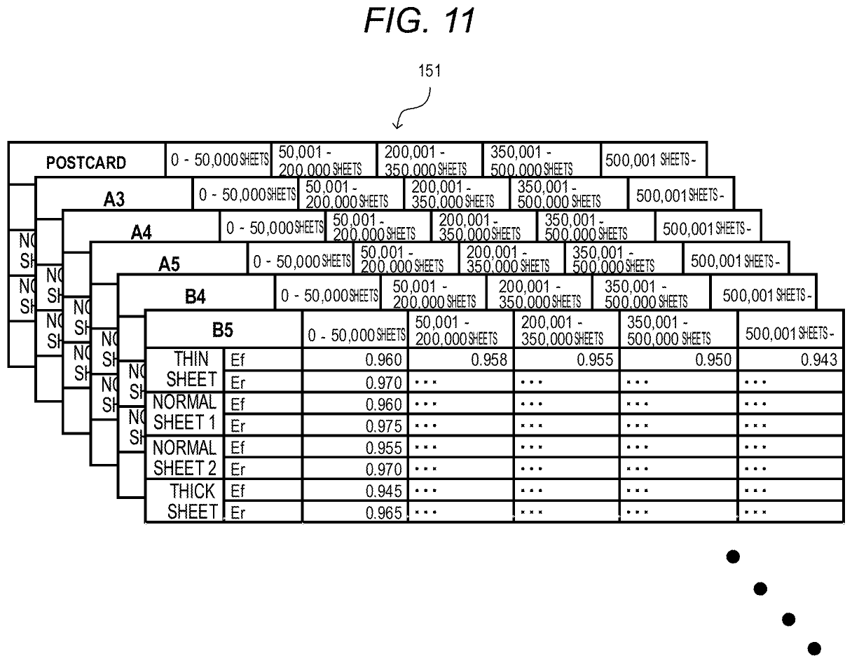

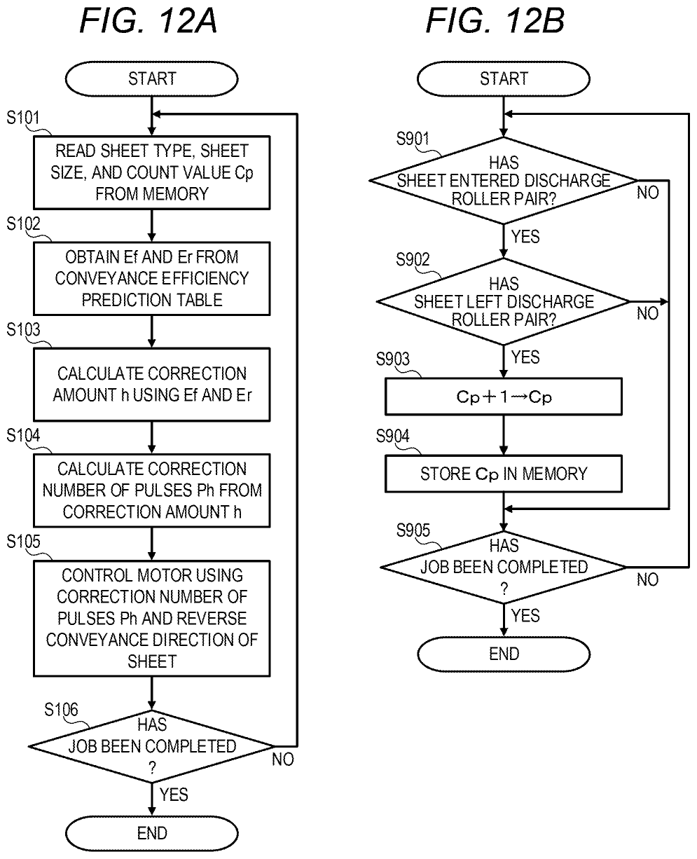

The second embodiment will hereinafter be described with reference to FIG. 9A, FIG. 9B, FIG. 10, FIG. 11, FIG. 12A, and FIG. 12B. In the second embodiment, the same structures as those in the first embodiment are denoted by the same reference numerals and the description thereof is omitted. The image forming apparatus 1 of the second embodiment is the same as that of the first embodiment, and therefore the description thereof will be omitted.

### (Conveyance Efficiency)

First, the conveyance efficiency will be described. Since the sheet S is driven by the frictional force with the discharge drive roller 38a, the sheet S is actually conveyed with a small slip. For example, even in a case in which the discharge drive roller 38a is rotated by one rotation, the sheet S is not conveyed for a distance corresponding to the circumferential length “dπ” of the discharge drive roller 38a, but is conveyed for a substantially circumferential length “dπ” with a conveyance loss of several percent. In the present specification, a ratio between an actual conveyance amount reflecting the conveyance loss and an ideal conveyance amount without the conveyance loss is expressed as the conveyance efficiency. As a result, even if the absolute value of the difference between the first distance L1 and the second distance L2 is ndπ, the phases of the discharge drive roller 38a at the start time and end time of the solo conveyance section by only the discharge roller pair 38, respectively, are not completely the same in phase because extra rotation is required for the conveyance loss.

Next, the cause of the skew amount Et caused by the effect of the conveyance efficiency will be described. FIG. 9A and FIG. 9B are explanatory views of an error occurring in the skew amount Et by the effect of the conveyance efficiency. FIG. 9A and FIG. 9B are shown in superimposing the results of conveying a plurality of sheets S. FIG. 9A is a view showing a relationship between the conveyance distance and the skew amount Et in the case in which an error occurs in the skew amount Et by the effect of the conveyance efficiency in the case in which the sheet S is switchback conveyed in the reverse discharge portion 50 of the first embodiment. Even if the absolute value of the difference between the first distance L1 and the second distance L2 is set to ndπ, the skew amount Et at the end time of conveyance by only the discharge roller pair 38 varies by the effect of the conveyance efficiency. In the second embodiment, the switchback position Psb is adjusted in consideration of the effect of the conveyance efficiency so that the phases of the discharge drive roller 38a are matched at the start time and end time of the solo conveyance section by only the discharge roller pair 38. Thereby, the fluctuation in the skew amount Et for each conveyance of the sheet S caused by the conveyance efficiency is reduced.

### (Reverse Discharge Portion)

FIG. 10 is a view showing a reverse discharge portion 150 according to the second embodiment. The sheet sensor 101 (detection unit) is provided immediately before the discharge roller pair 38 in the reverse discharge portion 150 according to the second embodiment. The sheet sensor 101 is connected to a cumulative sheet passing counter 160. The sheet sensor 101 detects the presence or absence of the sheet S. The cumulative sheet passing counter 160 counts a cumulative number of passing sheets S passing through the sheet sensor 101 based on a detection result of the sheet sensor 101. The reverse discharge portion 150 includes a UI 300 configured to set job conditions (printing conditions) by a user, a memory 110 configured to store data, the motor 104, and a controller 100 configured to control a timing for reversing the rotation of the motor 104. A conveyance efficiency prediction table 151 is stored in the memory 110. The controller 100 is electrically connected to the motor 104, the memory 110, the cumulative sheet passing counter 160, and the UI 300.

### (Prediction of Conveyance Efficiency)

Next, a description will be given of a method of predicting the conveyance efficiency and matching the phases of the discharge drive roller 38a at the start time and end time of the solo conveyance section by only the discharge roller pair 38. The conveyance efficiency is determined by the friction and sliding amount between the conveyed sheet S and the discharge roller pair 38. There are a sheet factor and a roller factor as major factors determining the conveyance efficiency. The sheet factor includes a sheet type. The roller factor includes roller durability information. The conveyance efficiency is predicted from the sheet type of the sheet S and the durability information of the roller. As the sheet type, sheet type information set by the user in advance by the UI 300 is used. As the roller durability information, a count value Cp of the cumulative sheet passing counter 160 configured to count the cumulative number of passing sheets S based on the detection result of the sheet sensor 101 provided in front of the discharge roller pair 38 is used. The conveyance efficiency prediction table 151 is prepared in advance for each size of the sheet S. Here, the size of the sheet S is the size in the unified standard such as A4 or B5. The conveyance efficiency prediction table 151 is obtained in advance from experiments and simulations. FIG. 11 is a view showing the conveyance efficiency prediction table 151. The controller 100 uses the conveyance efficiency prediction table 151 to predict the forward way conveyance efficiency Ef (first conveyance efficiency) and the backward way conveyance efficiency Er (second conveyance efficiency) in the case in which the sheet S is conveyed along the forward conveyance path F and the reverse conveyance path R by only the discharge roller pair 38.

Here, a method of determining the forward way conveyance efficiency Ef and the backward way conveyance efficiency Er (forward way conveyance efficiency prediction unit and backward way conveyance efficiency prediction unit) using the conveyance efficiency prediction table 151 will be described. The controller 100 selects the conveyance efficiency prediction table 151 corresponding to the sheet size set from the UI 300, and refers to a row corresponding to the sheet type. The controller 100 refers to a column within the numerical range corresponding to the count value Cp of the cumulative sheet passing counter 160 in the referred row. The controller 100 selects a set of forward way conveyance efficiency Ef and backward way conveyance efficiency Er from the conveyance efficiency prediction table 151 based on the three elements of the sheet size, the sheet type, and the count value Cp.

### (Calculation of Correction Amount)

Hereinafter, a method of calculating a correction amount “h” for correcting the switchback position Psb using the selected forward way conveyance efficiency Ef and backward way conveyance efficiency Er will be described. The controller 100 calculates the correction amount “h” for correcting the switchback position Psb for each conveyance of sheets S based on the selected forward way conveyance efficiency Ef and backward way conveyance efficiency Er, and sets an optimum corrected switchback position Psb1 based on the correction amount “h”. The correction amount “h” may be positive or negative. A distance by which the sheet S is conveyed from the position Pu at which the trailing edge of the sheet S leaves the discharge upstream roller pair 37 to the corrected switchback position Psb1 is a distance (L1+h) obtained by adding the correction amount “h” to the first distance L1, as shown in FIG. 10.

A relationship between the first distance L1 and the second distance L2 can be expressed by the following Equation (5) using the correction amount “h” for correcting the switchback position Psb so as to correct the error caused by the conveyance efficiency.

$$\vert \frac{L 2 + h}{Er} - \frac{L 1 + h}{Ef} \vert = n d π \qquad Equation ( 5 )$$

Here, “d” is the diameter of the discharge drive roller 38a, and “n” is an integer of 1 or more.

L2 is expressed by Equation (6) using L1.

L2=L1+ndπ (when L2>L1)

L2=L1−ndπ (when L2<L1) Equation (6)

Substituting Equation (6) into Equation (5) yields the following Equation (7).

$$\frac{L 1 + n d π + h}{Er} - \frac{L 1 + h}{Ef} = nd π ( when L 2 > L 1 ) \qquad Equation ( 7 )$$

$$\frac{L 1 + h}{Ef} - \frac{L 1 - n d π + h}{Er} = nd π ( when L 1 < L 2 )$$

By arranging Equation (7) by the correction amount “h”, the following Equation (8) is obtained.

$$h = n d π \frac{Ef ( 1 - E r )}{E r - Ef} - L 1 ( when L 2 > L 1 ) \qquad Equation ( 8 )$$

$$h = nd π \frac{Ef ( Er - 1 )}{E r - Ef} - L 1 ( when L 1 < L 2 )$$

Therefore, the correction amount “h” can be calculated from Equation (8) using the forward way conveyance efficiency Ef and the backward way conveyance efficiency Er selected from the conveyance efficiency prediction table 151.

FIG. 9B is a view showing a relationship between the conveyance distance and the skew amount Et in a case in which the switchback position Psb is corrected by the correction amount “h” and set to the corrected switchback position Psb1 in a case in which the second distance L2 is larger than the first distance L1 (L2>L1). By correcting the switchback position Psb using the correction amount “h” calculated by Equation (8), the error caused by the effect of the conveyance efficiency can be reduced.

### (Switchback Control Operation)

Referring to FIG. 12A and FIG. 12B, a processing flow of a switchback position correction control performed by the controller 100 will be described. FIG. 12A and FIG. 12B are flowcharts of a switchback control operation performed by the controller 100. In the second embodiment, the switchback control operation in a case in which the second distance L2 is larger than the first distance L1 (L2>L1) is described, but the same procedure can be used in a case in which the first distance L1 is larger than the second distance L2 (L1>L2). FIG. 12A is a flowchart of the switchback control operation in which the controller 100 switches back the sheet S at the corrected switchback position Psb1. FIG. 12B is a flowchart of a method of counting the cumulative number of passing sheets using the sheet sensor 101.

Referring to FIG. 12B, the controller 100 determines whether or not the sheet S has entered the discharge roller pair 38 based on the detection result of the sheet sensor 101 disposed immediately before the discharge roller pair 38 (S901). When the sheet sensor 101 is switched from OFF to ON, it is determined that the sheet S has entered the discharge roller pair 38. In a case in which it is determined that the sheet S has entered the discharge roller pair 38 (YES in S901), the controller 100 determines whether or not the sheet S has left the discharge roller pair 38 based on the detection result of the sheet sensor 101 (S902). In a case in which the sheet sensor 101 is switched from ON to OFF, it is determined that the sheet S has left the discharge roller pair 38. In a case in which it is determined that the sheet S has left the discharge roller pair 38 (YES in S902), the controller 100 determines that the sheet passing is completed, and increments the count value Cp of the cumulative sheet passing counter 160 of the discharge roller pair 38 by 1 (S903). The controller 100 stores the updated count value Cp in the memory 110 (S904). Counting of the cumulative number of passing sheets passed by the discharge roller pair 38 is performed in all printing including one-sided printing regardless of whether double-sided printing is performed or not. The controller 100 determines whether or not the job has been completed (S905). In a case in which the job has not been completed (NO in S905), the controller 100 returns the process to S901 and continues counting the cumulative number of passing sheets. In a case in which the job has been completed (YES in S905), the controller 100 ends the counting of the cumulative number of passing sheets.

Next, with reference to FIG. 12A, a switchback control operation in the double-sided printing will be described. When the switchback control operation is started, the controller 100 reads the sheet type and the sheet size, which are set by the user from the UI 300, and the count value Cp, from the memory 110 (S101). The controller 100 uses the sheet type, the sheet size, and the count value Cp to obtain the forward way conveyance efficiency Ef and the backward way conveyance efficiency Er from the conveyance efficiency prediction table 151 (S102). The sheet information including the sheet type and sheet size, the count value Cp of the cumulative sheet passing counter 160, and the conveyance efficiency prediction table 151 are stored in the memory 110. The controller 100 calculates a correction amount “h” for correcting the switchback position Psb by Equation (8) using the forward way conveyance efficiency Ef and the backward way conveyance efficiency Er (S103).

In the second embodiment, a pulse motor is used as the motor 104. A correction method of correcting a number of pulses of a pulse signal for controlling the motor 104 based on the correction amount “h” will be described. First, a before-correction rotation amount of the discharge drive roller 38a required for conveying the sheet S by the first distance L1 is L1/dn. An after-correction rotation amount of the discharge drive roller 38a required for conveying the sheet S by the distance (L1+h) corrected by the correction amount “h” in consideration of the effect of the forward way conveyance efficiency Ef is (L1+h)/(Ef×dπ). A corrected rotation amount Rot of the discharge drive roller 38a is calculated by subtracting the before-correction rotation amount from the after-correction rotation amount. The corrected rotation amount Rot of the discharge drive roller 38a is expressed by the following Equation (9).

$$R o t = \frac{L 1 + h}{Ef \times d π} - \frac{L 1}{d π} \qquad Equation ( 9 )$$

The corrected rotation amount Rot calculated by Equation (9) is converted into an angle (radian) and divided by a step angle Sa which is a rotation angle (circular measure) per one pulse of the pulse motor as the motor 104 to obtain a correction number of pulses Ph. The correction number of pulses Ph in consideration of the effects of the forward way conveyance efficiency Ef and the backward way conveyance efficiency Er is expressed by the following Equation (10).

$$P h = \frac{R o t}{S a} \times 2 π \qquad Equation ( 10 )$$

The circumferential length “dπ” of the discharge drive roller 38a, the step angle Sa of the motor 104, the first distance L1, the forward way conveyance efficiency Ef, and the correction amount “h” are stored in the memory 110. The controller 100 calculates the correction number of pulses Ph by Equation (10) using the circumferential length “dπ”, the step angle Sa, the first distance L1, the forward way conveyance efficiency Ef, and the correction amount “h” (S104).

The controller 100 controls the motor 104 with a pulse number obtained by adding the correction number of pulses Ph to a pulse number {(L1×2π)/(dπ×Sa)} for conveying the trailing edge of the sheet S by the first distance L1 from the position Pu to the switchback position Psb (S105). Thus, when the trailing edge of the sheet S reaches the corrected switchback position Psb1, the controller 100 can reverse (switchback) the conveyance direction of the sheet S. The controller 100 determines whether or not the job has been completed (S106). In a case in which the job has not been completed (NO in S106), the controller 100 returns the process to S101. In a case in which the job has been completed (YES in S106), the controller 100 ends the switchback control operation.

According to the second embodiment, the correction number of pulses Ph is calculated, and the motor 104 is controlled by the number of pulses corrected by the correction number of pulses Ph so that the sheet S can be reversed at the corrected switchback position Psb1. The correction number of pulses Ph is calculated by taking into consideration the forward way conveyance efficiency Ef and the backward way conveyance efficiency Er of the discharge roller pair 38 obtained from the conveyance efficiency prediction table 151 obtained experimentally in advance. Therefore, in the case in which the sheet S is switched back, the error in the phase of the discharge drive roller 38a caused by the conveyance efficiency of the discharge roller pair 38 can be reduced. Therefore, according to the second embodiment, fluctuations in the attitude of the sheet S in the case in which the conveyance direction of the sheet S is reversed can be reduced.

### Third Embodiment

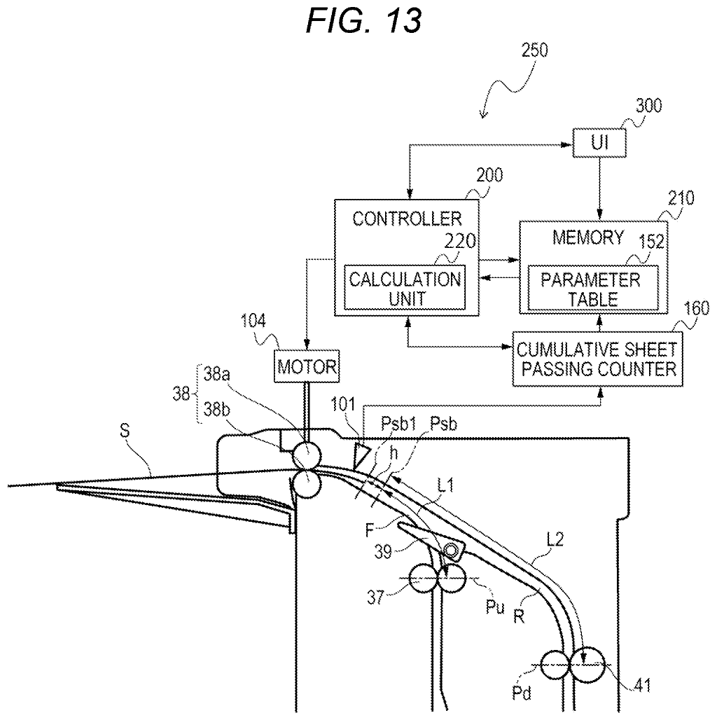

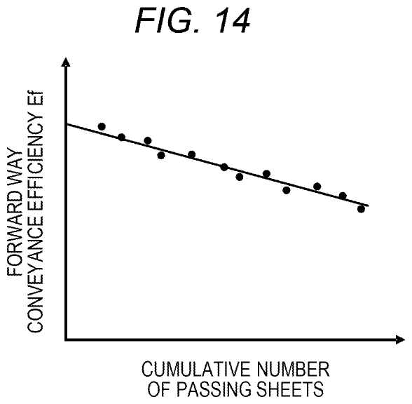

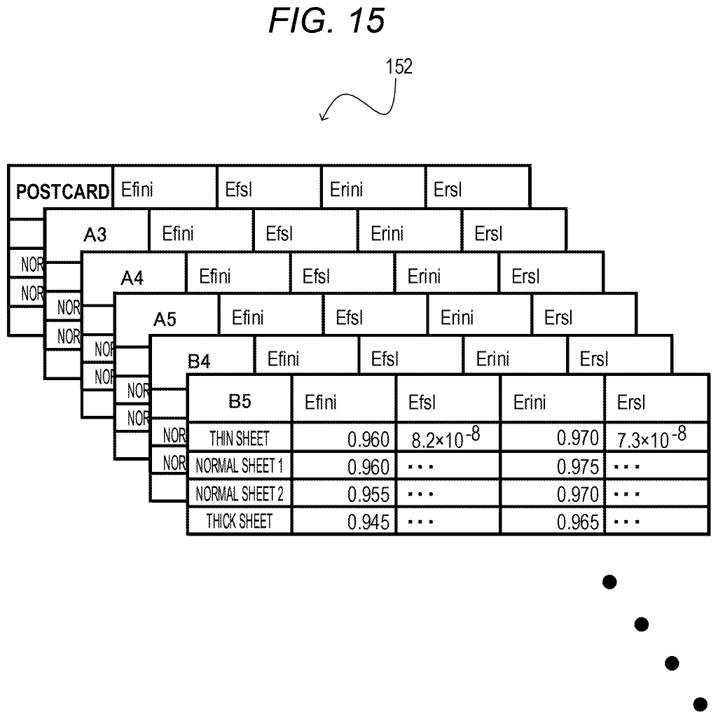

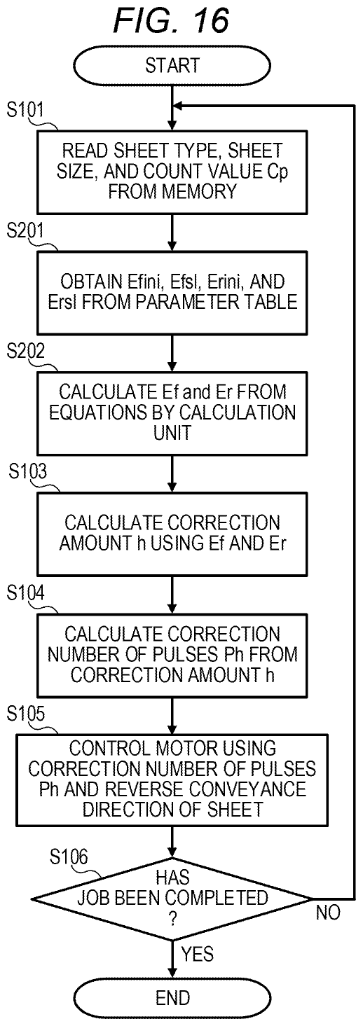

A third embodiment will be described below with reference to FIG. 13, FIG. 14, FIG. 15, and FIG. 16. In the third embodiment, the same structures as those in the second embodiment are denoted by the same reference numerals and the description thereof is omitted. The image forming apparatus of the third embodiment is the same as that of the first embodiment, and therefore the description thereof will be omitted. The third embodiment differs from the second embodiment in terms of a prediction unit and a prediction method for the forward way conveyance efficiency Ef and the backward way conveyance efficiency Er. In the third embodiment, the sheet information and the roller durability information are used as parameters, and the conveyance efficiency is formulated in advance. Each parameter is determined from actual job conditions, and conveyance efficiency is predicted from a mathematical formula using the determined parameters.

### (Reverse Discharge Portion)

FIG. 13 is a view showing a reverse discharge portion 250 according to the third embodiment. The sheet sensor 101 is provided immediately before the discharge roller pair 38 in the reverse discharge portion 250 according to the third embodiment. The sheet sensor 101 is connected to the cumulative sheet passing counter 160. The reverse discharge portion 250 includes the UI 300 configured to set job conditions by a user, a memory 210 configured to store data, the motor 104, and a controller 200 configured to control a timing for reversing the rotation of the motor 104. The memory 210 stores a parameter table 152. The controller 200 has a calculation unit 220. The controller 200 is electrically connected to the motor 104, the memory 210, the cumulative sheet passing counter 160, and the UI 300.

### (Mathematical Formulation of Conveyance Efficiency)

Next, a mathematical formulation of the forward way conveyance efficiency Ef and the backward way conveyance efficiency Er will be described. FIG. 14 is a view showing a relationship between the cumulative number of passing sheets and the forward way conveyance efficiency Ef. Note that a relationship between the cumulative number of passing sheets and the backward way conveyance efficiency Er is the same as that in FIG. 14, and therefore, an illustration thereof is omitted. The cumulative number of passing sheets is expressed by the count value Cp of the cumulative sheet passing counter 160. By the discharge roller pair 38 repeatedly conveying the sheet S, the surfaces of the front side rubber member 382a and the back side rubber member 383a of the discharge drive roller 38a and the surface of the discharge driven roller 38b are scraped, and the surface properties and rubber diameters of the rubber members are slightly changed. It is known that the conveyance efficiency is lowered by these effects. As shown in FIG. 14, the relationship between the cumulative number of passing sheets and the forward way conveyance efficiency Ef (or the backward way conveyance efficiency Er) during the endurance of the discharge roller pair 38 is approximately linearly expressed. A conveyance efficiency prediction formula of the forward way conveyance efficiency Ef obtained from the relationship is shown in Equation (11), and a conveyance efficiency prediction formula of the backward way conveyance efficiency Er is shown in Equation (12).

Ef=Efini−Efsl×Cp Equation (11)

Er=Erini−Ersl×Cp Equation (12)

Equation (11) is a formula for calculating the forward way conveyance efficiency Ef using the count value Cp of the cumulative sheet passing counter 160 as the cumulative number of passing sheets, an initial conveyance efficiency Efini in the forward conveyance path F, and a decreasing amount Efsl of the conveyance efficiency in association with an increase of the cumulative number of passing sheets in the forward conveyance path F. Equation (12) is a formula for calculating the backward way conveyance efficiency Er using the count value Cp, an initial conveyance efficiency Erini in the reverse conveyance path R, and a decreasing amount Ersl of the conveyance efficiency in association with an increase of the cumulative number of passing sheets in the reverse conveyance path R.

In the second embodiment, the calculation unit 220 calculates the forward way conveyance efficiency Ef and the backward way conveyance efficiency Er by using Equation (11) and Equation (12). The initial conveyance efficiency Efini in the forward conveyance path F, the decreasing amount Efsl of the conveyance efficiency in the forward conveyance path F, the initial conveyance efficiency Erini in the reverse conveyance path R, and the decreasing amount Ersl of the conveyance efficiency in the reverse conveyance path R are different for each sheet type and sheet size. FIG. 15 is a view showing a parameter table 152. By referring to the sheet size and the sheet type in the parameter table 152, a set of the initial conveyance efficiency Efini, the decreasing amount Efsl, the initial conveyance efficiency Erini and the decreasing amount Ersl corresponding to the combination of the sheet size and the sheet type can be selected from the parameter table 152. The parameter table 152 is stored in the memory 210.

Hereinafter, a method of determining the forward way conveyance efficiency Ef and the backward way conveyance efficiency Er using Equation (11), Equation (12), and the parameter table 152 will be described. In the same manner as in the second embodiment, the sheet type and sheet size are obtained from the UI 300, and the count value Cp is obtained from the cumulative sheet passing counter 160. The parameter table 152 corresponding to the sheet size is referred to, and a row corresponding to the sheet type is referred to. Using the initial conveyance efficiency Efini, the decreasing amount Efsp, the initial conveyance efficiency Erini and the decreasing amount Ersp of the row, the calculation unit 220 calculates the forward way conveyance efficiency Ef and the backward way conveyance efficiency Er from Equation (11) and Equation (12), respectively.

### (Switchback Control Operation)

A processing flow of a switchback position correction control by the controller 200 will be described with reference to FIG. 16. FIG. 16 is a flowchart of a switchback control operation performed by the controller 200. In the third embodiment, the method of counting the cumulative number of passing sheets using the sheet sensor 101 is the same as in the second embodiment shown in FIG. 12B, and therefore a description thereof will be omitted. In the second embodiment, the forward way conveyance efficiency Ef and the backward way conveyance efficiency Er are obtained by referring to the conveyance efficiency prediction table 151 (S102 in FIG. 12A). On the other hand, in the third embodiment, the forward way conveyance efficiency Ef and the backward way conveyance efficiency Er are obtained by referring to the parameter table 152 stored in the memory 210.

When the switchback control operation is started, the controller 200 reads the sheet type, the sheet size, and the count value Cp from the memory 210 (S101). The controller 200 uses the sheet type, the sheet size, and the count value Cp to obtain the initial conveyance efficiency Efini, the decreasing amount Efsl, the initial conveyance efficiency Erini, and the decreasing amount Ersl from the parameter table 152 (S201). The controller 200 uses the initial conveyance efficiency Efini, the decreasing amount Efsp, the initial conveyance efficiency Erini, and the decreasing amount Ersp to calculate the forward way conveyance efficiency Ef and the backward way conveyance efficiency Er from Equation (11) and Equation (12), respectively, by the calculation unit 220 (S202).

The controller 200 calculates the correction amount “h” for correcting the switchback position Psb by Equation (8) using the forward way conveyance efficiency Ef and the backward way conveyance efficiency Er (S103). The controller 200 calculates the correction number of pulses Ph by Equation (10) using the circumferential length “dπ”, the step angle Sa, the first distance L1, the forward way conveyance efficiency Ef, and the correction amount “h” (S104). The controller 200 controls the motor 104 with the number of pulses corrected by the correction number of pulses Ph, and reverses (switches back) the conveyance direction of the sheet S (S105). Thereafter, the same control operation is repeated until the job is completed (S106).

According to the third embodiment, the forward way conveyance efficiency Ef and the backward way conveyance efficiency Er can be predicted with high accuracy from Equation (11) and Equation (12) as the conveyance efficiency prediction equations. The error in the phase of the discharge drive roller 38a caused by the conveyance efficiency of the discharge roller pair 38 can be reduced by calculating the correction amount “h” using the forward way conveyance efficiency Ef and the backward way conveyance efficiency Er obtained from the conveyance efficiency prediction equations, and correcting the reversal position. Compared with the conveyance efficiency prediction table 151 of the second embodiment, by using the conveyance efficiency prediction equations, it is possible to reduce the amount of parameters that need to be stored. Thus, the capacity usage of the memory 210 can be reduced. According to the third embodiment, fluctuations in the attitude of the sheet S in the case in which the conveyance direction of the sheet S is reversed can be reduced.

### Other Embodiments

Embodiments of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2021-132287, filed Aug. 16, 2021, which is hereby incorporated by reference herein in its entirety.

What is claimed is:

1. An image forming apparatus configured to form an image on a recording medium, the image forming apparatus comprising:
a reverse roller pair including a drive roller and a driven roller driven by a rotation of the drive roller, and configured to reverse a conveyance direction of the recording medium between a first direction and a second direction opposite to the first direction;
a motor configured to drive the drive roller;
a first conveyance roller pair disposed upstream of the reverse roller pair in the first direction and configured to convey the recording medium in the first direction; and
a second conveyance roller pair disposed downstream of the reverse roller pair in the second direction and configured to convey the recording medium in the second direction,
wherein in a case in which a distance between the first conveyance roller pair and a reversal position in which a trailing edge of the recording medium conveyed in the first direction is located when the conveyance direction is reversed from the first direction to the second direction by the reverse roller pair is assumed to be a first distance and a distance between the reversal position and the second conveyance roller pair is assumed to be a second distance, the reverse roller pair, the first conveyance roller pair, and the second conveyance roller pair are configured so that an absolute value of a difference between the first distance and the second distance is an integer multiple of a circumferential length of the drive roller or within a predetermined range from the integer multiple.

2. The image forming apparatus according to claim 1, wherein the predetermined range is a range of values of ±0.076 times the circumferential length of the drive roller.

3. The image forming apparatus according to claim 1, further comprising a controller,
wherein the controller
predicts a first conveyance efficiency of the recording medium in a first conveyance path between the first conveyance roller pair and the reverse roller pair, and a second conveyance efficiency of the recording medium in a second conveyance path between the reverse roller pair and the second conveyance roller pair,
calculates a correction amount for correcting the reversal position by using the first conveyance efficiency and the second conveyance efficiency, and
control the motor based on the correction amount.

4. The image forming apparatus according to claim 3, further comprising a memory configured to store the first conveyance efficiency and the second conveyance efficiency corresponding to a printing condition.

5. The image forming apparatus according to claim 3, further comprising:
a memory configured to store a parameter corresponding to a printing condition; and
a calculation unit configured to calculate the first conveyance efficiency and the second conveyance efficiency by using the parameter.

6. The image forming apparatus according to claim 4, wherein the printing condition includes a size and a type of the recording medium.

7. The image forming apparatus according to claim 3, wherein a relationship as below is satisfied,
$$h = nd π \frac{Ef ( 1 - Er )}{Er - Ef} - L 1 ( when L 2 > L 1 )$$
$$h = nd π \frac{Ef ( Er - 1 )}{Er - Ef} - L 1 ( when L 1 < L 2 )$$
where “d” is a diameter of the drive roller, L1 is the first distance, L2 is the second distance, Ef is the first conveyance efficiency, Er is the second conveyance efficiency, “h” is the correction amount, and “n” is an integer value.

8. The image forming apparatus according to claim 1, further comprising:
an image forming portion configured to form the image on the recording medium; and
a discharge tray on which the recording medium on which the image is formed by the image forming portion is stacked,
wherein the reverse roller pair discharges the recording medium on which the image is formed by the image forming portion to the discharge tray.
